(19) United States
(12) Patent Application Publication
(10) Pub. No.: US 2011/0126437 A1
(43) Pub. Date: Jun. 2, 2011

(54) GREETING CARD WITH COMPARTMENT

(76) Inventor: Cathy Lynn Bullington, Crown Point, IN (US)

(21) Appl. No.: 12/780,442

(22) Filed: May 14, 2010

Related U.S. Application Data
(60) Provisional application No. 61/178,140, filed on May 14, 2009.

(51) Int. Cl. G09F 1/04

(52) U.S. Cl. 40/124.06

(57) ABSTRACT

A greeting card configured to contain a gift, such as a monetary gift or gift card, within a sleeve that secures the gift within a compartment within the card. The card includes at least one leaf and preferably first and second leaves interconnected by at least one fold line. The compartment is disposed within the second leaf, and the sleeve slidably protrudes from the compartment through a slot. The sleeve has a pair of lateral edges between forward and rearward edges thereof, and at least one of the lateral edges is open for receiving a gift that when disposed in the sleeve can be concealed within the compartment. The sleeve is transparent such that a gift disposed in the sleeve is visible if the sleeve protrudes from the compartment.

### CROSS REFERENCE TO RELATED APPLICATIONS

This application claims the benefit of U.S. Provisional Application No. 61/178,140, filed May 14, 2009, the contents of which are incorporated herein by reference.

### BACKGROUND OF THE INVENTION

The present invention generally relates to greeting cards and packages. More particularly, this invention relates to a greeting card that contains an enclosed compartment for securing a gift, such as a monetary gift or gift card, and is capable of being configured to appear as a gift-wrapped package.

Greeting cards are commercially available that are configured for enclosing a gift, such as a monetary gift or gift card. A common example is a bifold greeting card with one of its leaves equipped with a third fold sized to contain a gift card or monetary gift. Other examples are greeting cards having a leaf in which four slits are located to receive the corners of a standard-sized gift card. In addition, greeting cards are available with gift bags attached to an outer surface thereof in which a gift card or a monetary gift can be placed. Other available configurations include greeting cards equipped with a box-type container in which a gift card or monetary gift can be placed.

A drawback of conventional gift-bearing greeting cards is that the gift may fall out of the card when the recipient opens the card to expose the gift. Furthermore, the gifting experience is somewhat lessened because the gift is often immediately exposed when the greeting card is opened.

### BRIEF DESCRIPTION OF THE INVENTION

The present invention provides a greeting card configured to contain a gift, including but not limited to monetary gifts and gift cards, within a sleeve that secures the gift within a compartment within the greeting card, and in which the gift remains secured even after being withdrawn from the compartment.

According to a preferred aspect of the invention, the greeting card includes at least one leaf and preferably first and second leaves having at least one fold line therebetween through which the leaves are connected to enable the leaves to pivot toward and away from each other. A compartment is disposed within the second leaf, and a sleeve slidably protrudes from the compartment through a slot in the second leaf. The sleeve has a maximum extent from the slot in which more of the sleeve is outside the compartment than within the compartment, and has a minimum extent from the slot in which more of the sleeve is within the compartment than outside the compartment. The sleeve has a forward edge outside the slot when the sleeve is at its minimum and maximum extents, and a rearward edge within the compartment when the sleeve is at its minimum and maximum extents. The sleeve further has a pair of lateral edges between the forward and rearward edges, with at least one of the lateral edges being open for receiving a gift that when disposed in the sleeve is concealed within the compartment if the sleeve is at its minimum extent relative to the slot. The sleeve is transparent such that a gift disposed in the sleeve is visible if the sleeve is at its maximum extent relative to the slot.

A significant advantage of this invention is that the sleeve enables a gift, such as a monetary gift or gift card, to be safely stowed within a greeting card, regardless of whether the greeting card is unfolded or not and regardless of whether the recipient has drawn the sleeve from its compartment to view the gift. The sleeve is an integral part of the greeting card that eliminates the need for a separate gift receptacle, and is preferably configured to be nonremovable without pulling the greeting card apart. The greeting card is also readily adaptable to appear as a gift-wrapped package box.

Other aspects and advantages of this invention will be better appreciated from the following detailed description.

### BRIEF DESCRIPTION OF THE DRAWINGS

FIG. 1 is a front view of a tri-fold greeting card in accordance with a first embodiment of this invention.

FIG. 2 is a front view of the greeting card of FIG. 1, with an outer leaf of the card opened to expose a second leaf of the card.

FIG. 3 is a front view of the greeting card of FIG. 1, with the second leaf of the card opened to expose a third leaf of the card between the outer and second leaves.

FIG. 4 is a front view of a tri-fold greeting card in accordance with a second embodiment of this invention.

FIG. 5 is a front view of the greeting card of FIG. 4, with an outer leaf of the card opened to expose a second leaf of the card.

FIG. 6 is a front view of a bifold greeting card in accordance with a third embodiment of this invention.

FIGS. 7 and 8 are front views of the greeting card of FIG. 6, with an outer leaf of the card opened to expose a second leaf of the card.

FIGS. 9 and 10 are front views of a non-folding greeting card in accordance with a fourth embodiment of this invention.

### DETAILED DESCRIPTION OF THE INVENTION

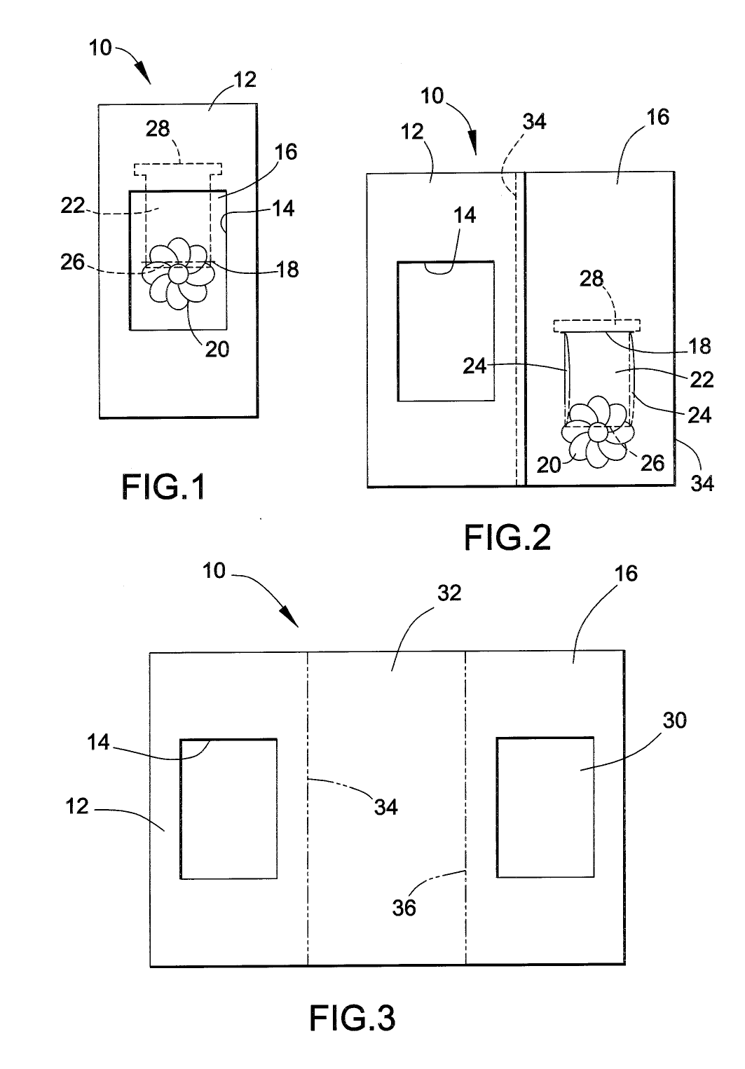

FIGS. 1 through 10 represent greeting cards 10, 110, 210 and 310 corresponding to four nonlimiting embodiments of the present invention. To facilitate the descriptions of the cards 10, 110, 210 and 310 provided below, the terms “front,” “rear,” “side,” “upper,” “lower,” “above,” “below,” “right,” “left,” etc., will be used in reference to the intended orientation of the cards 10, 110, 210 and 310 during the process of holding and opening the cards 10, 110, 210 and 310, and therefore are relative terms and should not be otherwise interpreted as limitations to the construction and use of the cards 10, 110, 210 and 310. It should be further noted that the drawings are drawn for purposes of clarity when viewed in combination with the following description, and therefore are not necessarily to scale.

The first embodiment illustrated in FIGS. 1 through 3 is of a tri-fold greeting card 10 comprising three interconnected leaves 12, 16 and 32. The card 10 and its leaves 12, 16 and 32 can be fabricated from any suitable material or materials. A first of the leaves 12, 16 and 32 is generally an outer or front leaf 12, on which a greeting may be printed or otherwise displayed. A second of the leaves will be referred to as a gift-bearing leaf 16, and the third leaf 32 is an interior leaf connected to the front and gift-bearing leaves 12 and 16 through two folds 34 and 36. The front leaf 12 has an open window 14 defined therein through which a central region of the gift-bearing leaf 16 is exposed. The window 14 is preferably sized to expose a slot 18 defined in the leaf 16, as well as a name tag, note card, ribbon or bow 20 attached to a sleeve 22 that protrudes from the slot 18. The sleeve 22 is configured to be slidably received within a pocket or compartment 30 defined entirely within the leaf 16 and whose access at the outer surface of the leaf 16 is formed by the slot 18. Alternatively, the compartment 30 could be defined by another leaf attached to and folded onto the leaf 16 to form the compartment 30 and its slot 18. FIGS. 1 and 2 show the slot 18 as oriented perpendicular to the fold 34 and the sleeve 22 adapted to be drawn toward a lower edge of the card 10, though such an arrangement is not required.

The sleeve 22 is further configured to have a deployed or maximum extension from the compartment 30 in which most of the sleeve 22 is outside the compartment 30, and a stowed or minimum extension from the compartment 30 in which most of the sleeve 22 is within the compartment 30. The sleeve 22 comprises an outer or forward edge 26 that remains exposed outside the slot 18 in both the deployed and stowed positions of the sleeve 22, and an inner or rearward edge 28 that remains within the compartment 30 regardless of whether the sleeve 22 is at its minimum or maximum extension relative to the slot 18. To retain the sleeve 22 in its stowed position, its forward edge 26 may be provided with a retention feature, such as complementary hook-and-loop (e.g., VELCRO®) patches on the edge 26 and the surface of the leaf 16 beneath the edge 26 when the sleeve 22 is stowed within the compartment 30. To retain the rearward edge 28 of the sleeve 22 within the compartment 30 in both the stowed and deployed positions, the rearward edge 28 is represented in FIGS. 1 and 2 as being wider than the slot 18. In the configuration shown, the rearward edge 28 is also wider than the forward edge 28 of the sleeve 22 as well as the bulk of the sleeve 22 between the forward and rearward edges 26 and 28. Other means for retaining the rearward edge 28 within the compartment 30 are also within the scope of the invention.

The sleeve 22 is further represented as having two lateral edges 24 that interconnect the forward and rearward edges 26 and 28 of the sleeve 22. According to a preferred aspect of the invention, one or more interior pockets are defined within the sleeve 22, and at least one of the edges 24 defines an opening into the one or more pockets. At least one pocket is preferably sized to accommodate a monetary gift, such as a check or cash, or a standard-sized gift card, a typical example of which has a shape and size similar to a credit card (specified by the ISO/IEC 7810 standard as ID-1 and having dimensions of about 85.60 by 53.98 mm). The edges 24 are essentially entirely within the compartment 30 when the sleeve 22 is stowed at its minimum extension from the slot 18, but are essentially entirely exposed outside the compartment 30 when the sleeve 22 is fully deployed at its maximum extension. The interior of the compartment 30 is shown as closely corresponding in size and shape (e.g., rectangular) to the sleeve 22, such that a monetary gift or gift card placed in the sleeve 22 is unlikely to become dislodged from the sleeve 22 while the sleeve 22 is stowed within the compartment 30. Accordingly, a monetary gift or gift card can be placed through one of the open edges 24 and into the sleeve 22 when the sleeve 22 is at least partially drawn from its compartment 30, and then safely secured within the compartment 30 by pushing the sleeve 22 into the compartment 30 through the slot 18. According to another preferred aspect of the invention, the sleeve 22 is preferably transparent or at least sufficiently translucent so that a gift placed within the sleeve 22 is visible through the sleeve 22. As such, by pulling the sleeve 22 from its compartment 30 to its maximum extent, one is able to see the contents of the sleeve 22 while the contents remain within the sleeve 22, and then return the sleeve 22 to its stowed position within the compartment 30 in order to safely enclose and secure the gift within the compartment 30.

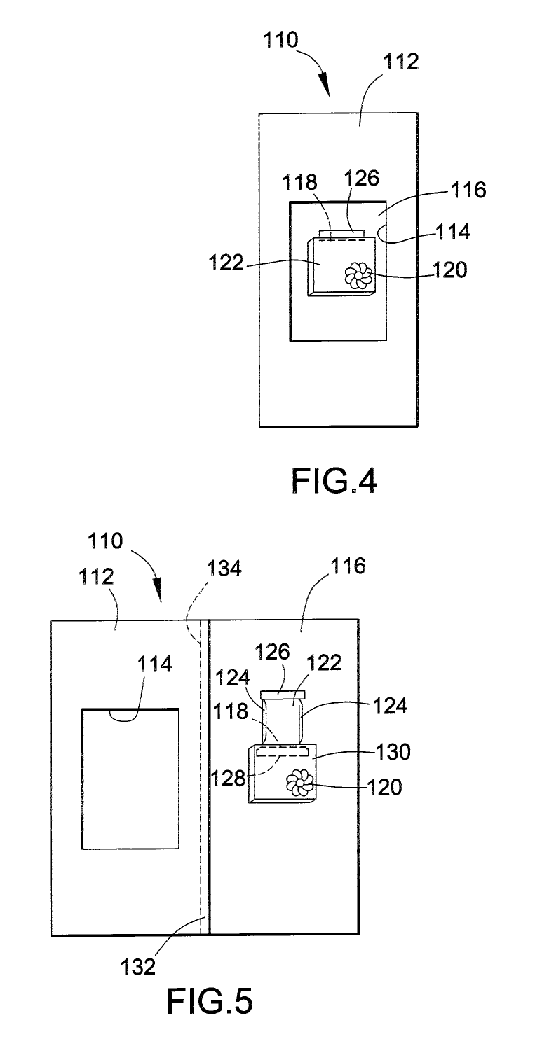

The second embodiment illustrated in FIGS. 4 and 5 is also a tri-fold greeting card 110 comprising three interconnected leaves 112, 116 and 132. In FIGS. 4 and 5, consistent reference numbers are used to identify the same or functionally equivalent elements to those of FIGS. 1 through 3, but with a numerical prefix (1) added to distinguish the second embodiment from the first embodiment. In view of similarities between the first and second embodiments, the following discussion of FIGS. 4 and 5 will focus primarily on aspects of the second embodiment that differ from the first embodiment in some notable or significant manner. Other aspects of the second embodiment not discussed in any detail can be, in terms of structure, function, materials, etc., essentially as was described for the first embodiment.

Similar to the greeting card 10 of FIGS. 1 through 3, the leaves 112, 116 and 132 of the greeting card 110 are configured as a front leaf 112, a gift-bearing leaf 116, and a third leaf 132 that interconnects the front and gift-bearing leaves 112 and 116 through two folds 134 and 136. Furthermore, the front leaf 112 has an open window 114 defined therein that is sized to expose a slot 118 defined in the leaf 116, as well as a note card, name tag, ribbon or bow 120 attached to a sleeve 122 that protrudes from the slot 118. The embodiment of FIGS. 4 and 5 primarily differs from the greeting card 10 of FIGS. 1 through 3 as a result of the sleeve 122 being slidably received within a compartment 130 defined as a box 130 formed, attached or otherwise disposed on the exterior surface of the leaf 116, and with the slot 118 being defined in the box 130 and not on the leaf 116. In combination with the note card, name tag, ribbon or bow 120 attached to the sleeve 122, the box 130 has the appearance of a gift box displayed through the window 114 of the card 110. FIGS. 4 and 5 show the slot 118 oriented perpendicular to the fold 134 and the sleeve 122 adapted to be drawn toward an upper edge of the card 110, though such an arrangement is not required. Otherwise, the sleeve 122 is again configured to accommodate a monetary gift or a standard-sized gift card, and is preferably transparent or translucent to allow viewing of a gift within the sleeve 122. Furthermore, the sleeve 122 has maximum and minimum extensions (deployed and stowed positions) relative to the box (compartment) 130, closed forward and rearward edges 126 and 128, and open lateral edges 124, and the box 130 is configured to define an interior that is sized and shaped to closely receive the sleeve 122 so as to help retain a gift within the sleeve 122 when the sleeve 122 is stowed within the compartment 130. An advantage of the box 130 is the ability to accommodate a larger and/or thicker sleeve 122, allowing for the stowing and displaying of larger and particularly thicker gifts within the sleeve 122.

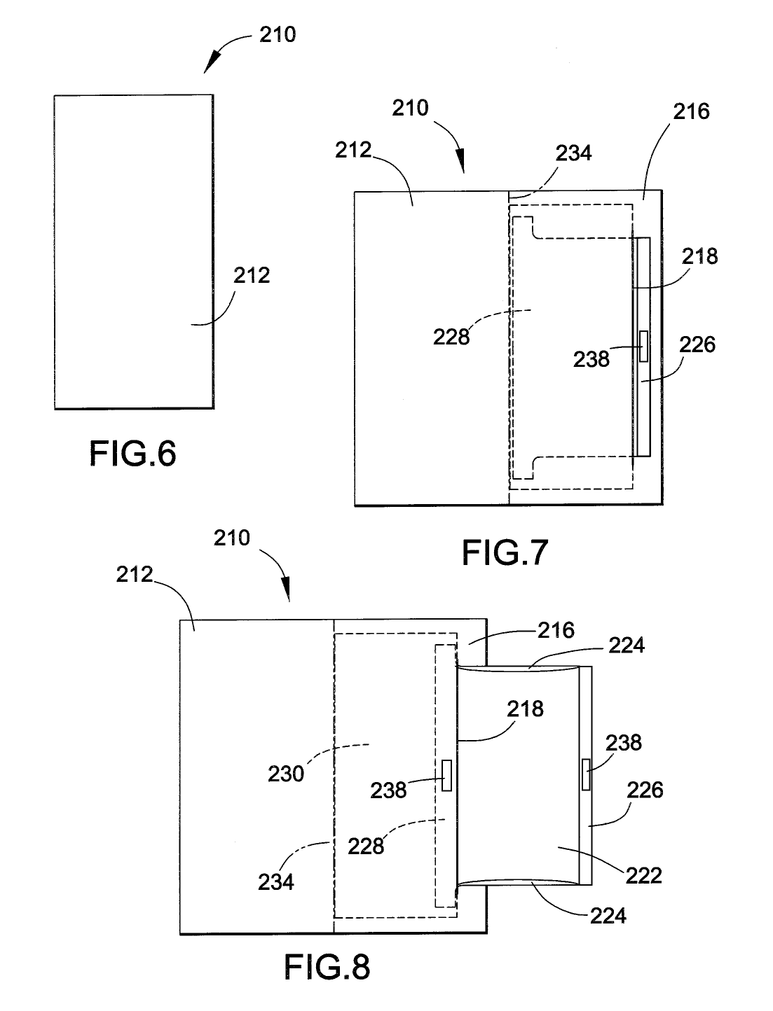

The third embodiment illustrated in FIGS. 6, 7 and 8 is configured as a bifold greeting card 210 comprising two leaves 212 and 216 connected by a single fold 234. As with the first and second embodiments of FIGS. 1 through 5, consistent reference numbers are used in FIGS. 6 through 8 to identify the same or functionally equivalent elements to those of FIGS. 1 through 5, but with a numerical prefix (2) added to distinguish the third embodiment from the first and second embodiments. Furthermore, in view of similarities among the embodiments, the following discussion of FIGS. 6 through 8 will focus primarily on aspects of the third embodiment that differ from the first and second embodiments in some notable or significant manner. Other aspects of the third embodiment not discussed in any detail can be, in terms of structure, function, materials, etc., essentially as was described for the first embodiment.

Similar to the greeting cards 10 and 110 of FIGS. 1 through 5, the leaves 212 and 216 of the greeting card 210 are configured as front and gift-bearing leaves 212 and 216, respectively, but the card 210 lacks a third leaf that interconnects the front and gift-bearing leaves 212 and 216. Furthermore, the front leaf 212 lacks an open window of the type shown in FIGS. 1 through 5. Instead, a slot 218 defined in the gift-bearing leaf 216 and a sleeve 222 slidably received in the slot 218 can be exposed by opening the front leaf 212 relative to the gift-bearing leaf 216. As with the embodiment of FIGS. 1 through 3, the sleeve 222 of the greeting card 210 is slidably received within a compartment 230 defined as a pocket within the leaf 216, as opposed to a discrete box of a type similar to that shown in FIGS. 4 and 5. Contrary to the embodiments of FIGS. 1 through 5, FIGS. 7 and 8 show the slot 218 as oriented parallel to the fold 234, such that the sleeve 222 is adapted to be drawn toward a lateral edge of the card 210, though such an arrangement is not required. An advantage of the placement and configuration of the sleeve 222 shown in FIGS. 7 and 8 is the ability to stow and display larger gifts with relatively little movement of the sleeve 222. The sleeve 222 is again configured to accommodate a monetary gift or a standard-sized gift card, and is preferably transparent or translucent to allow viewing of a gift within the sleeve 222. Furthermore, the sleeve 222 has maximum and minimum extensions (deployed and stowed positions) relative to the compartment 230, closed forward and rearward edges 226 and 228, and open lateral edges 224, and the compartment 230 is configured to define an interior that is sized and shaped to closely receive the sleeve 222 so as to help retain a gift within the sleeve 222 when the sleeve 222 is stowed within the compartment 230. To retain the sleeve 222 in its stowed position, its forward edge 226 may be provided with a retention feature, represented in FIGS. 7 and 8 as complementary hook-and-loop patches 238 on the edge 226 and the surface of the leaf 216 beneath the edge 226 when the sleeve 222 is stowed within the compartment 230.

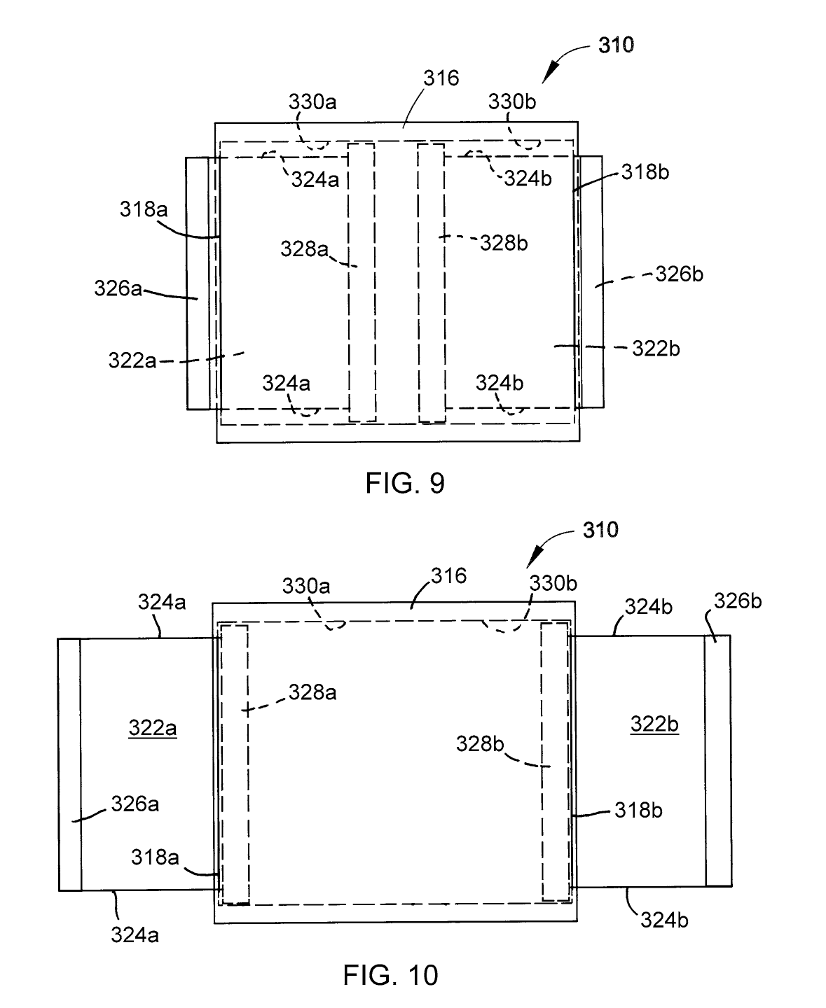

Finally, the fourth embodiment illustrated in FIGS. 9 and 10 is configured as a non-folding greeting card 310 having a single leaf 216 without any folds. As with the prior embodiments of FIGS. 1 through 8, consistent reference numbers are used in FIGS. 9 and 10 to identify the same or functionally equivalent elements to those of FIGS. 1 through 8, but with a numerical prefix (3) added to distinguish the fourth embodiment from the prior embodiments. Furthermore, in view of similarities among the embodiments, the following discussion of FIGS. 9 and 10 will focus primarily on aspects of the fourth embodiment that differ from the prior embodiments in some notable or significant manner. Other aspects of the fourth embodiment not discussed in any detail can be, in terms of structure, function, materials, etc., essentially as was described for the prior embodiments.

Similar to the leaves 16, 116 and 216 of the greeting cards 10, 110 and 210 of FIGS. 1 through 8, the leaf 316 of the greeting card 310 is configured as a gift-bearing leaf 316. In addition to lacking a front or cover leaf of the prior embodiments, the leaf 316 is formed to have a pair of slots 318a and 318b defined adjacent its lateral edges, each of which forms an opening to a compartment 330a and 330b in which a sleeve 322a and 322b is slidably received in a manner similar to the sleeves 22, 122 and 222 of the prior embodiments. The compartments 330a and 330b may be portions of a single continuous cavity within the card 310 as shown, though it is also within the scope of the invention that the compartments 330a and 330b could be defined by two separate cavities separated by a wall (not shown). Each sleeve 322a and 322b has a maximum and minimum extension (deployed and stowed position) relative to its respective compartment 330a and 330b, a closed forward edge 326a and 326b, a closed rearward edge 328a and 328b, and open lateral edges 324a and 324b. Similar to the embodiment of FIGS. 7 and 8, the slots 318a and 318b are oriented parallel to the lateral edges of the leaf 316, such that the sleeves 322a and 322b are each adapted to be drawn laterally outward from the card 310. At least one of the sleeves 322a and 322b is configured to accommodate a monetary gift or a standard-sized gift card, while the second sleeve 322a or 322b may be sized to receive a personalized note card. To enable the recipient to quickly view of the gift and note, both sleeves 322a and 322b are preferably transparent or translucent. Each compartment 330a and 330b is sized and shaped to closely receive its sleeve 322a or 322b so as to help retain the card or gift within the sleeve 322a/322b when the sleeve 322a/322b is stowed within the compartment 330a/330b.

While the invention has been described in terms of specific embodiments, it is apparent that other forms could be adopted by one skilled in the art. For example, the physical configurations of the greeting cards 10, 110, 210 and 310 could differ from those shown, and various materials and processes could be used to fabricate the cards 10, 110, 210 and 310. Therefore, the scope of the invention is to be limited only by the following claims.

1. A greeting card comprising:
first and second leaves having at least one fold line therebetween through which the first and second leaves are connected to enable the first and second leaves to pivot toward and away from each other;
a compartment within the second leaf; and
a sleeve slidably protruding from the compartment through a slot in the second leaf so as to have a maximum extent from the slot in which more of the sleeve is outside the compartment than within the compartment and a minimum extent from the slot) in which more of the sleeve is within the compartment than outside the compartment, the sleeve having a forward edge outside the slot when the sleeve is at the minimum and maximum extents and a rearward edge within the compartment when the sleeve is at the minimum and maximum extents, the sleeve having a pair of lateral edges between the forward and rearward edges at least one of the lateral edges being open for receiving a gift that when disposed in the sleeve is concealed within the compartment if the sleeve is at the minimum extent relative to the slot, the sleeve being transparent such that a gift disposed in the sleeve is visible if the sleeve is at the maximum extent relative to the slot.

2. The greeting card according to claim 1, wherein the compartment is concealed within the second leaf.

3. The greeting card according to claim 1, wherein the compartment is a box disposed at an outer surface of second leaf.

4. The greeting card according to claim 1, further comprising a window defined in the first leaf, wherein the forward edge of the sleeve is visible within the window when the first leaf is folded onto the second leaf.

5. The greeting card according to claim 4, further comprising at least one attachment attached to the forward edge of the sleeve and chosen from the group consisting of note cards, name tags, ribbon and bows, and the attachment protrudes through the window when the first leaf is folded onto the second leaf.

6. The greeting card according to claim 4, further comprising an attachment attached to the compartment and chosen from the group consisting of note cards, name tags, ribbon and bows, and the attachment protrudes through the window when the first leaf is folded onto the second leaf.

7. The greeting card according to claim 4, wherein the compartment is a box disposed at an outer surface of second leaf and the box protrudes through the window when the first leaf is folded onto the second leaf.

8. The greeting card according to claim 7, further comprising at least one attachment attached to the compartment and chosen from the group consisting of note cards, name tags, ribbon and bows, and the attachment protrudes through the window when the first leaf is folded onto the second leaf.

9. The greeting card according to claim 1, wherein the at least one fold line comprises a first fold line that directly connects the first leaf with a third leaf of the greeting card between the first and second leaves and a second fold line that directly connects the second leaf with the third leaf.

10. The greeting card according to claim 1, wherein the at least one fold line is a single fold line that directly connects the first and second leaves.

11. The greeting card according to claim 1, wherein the compartment corresponds in size and shape to the sleeve.

12. The greeting card according to claim 1, wherein the sleeve and the compartment each have a size and shape to accommodate a monetary gift or a gift card.

13. The greeting card according to claim 1, wherein the slot is perpendicular to the at least one fold line.

14. The greeting card according to claim 1, wherein the slot is parallel to the at least one fold line.

15. The greeting card according to claim 1, further comprising means for retaining the rearward edge of the sleeve within the compartment.

16. The greeting card according to claim 1, wherein the rearward edge of the sleeve is wider than the slot.

17. The greeting card according to claim 1, wherein the rearward edge of the sleeve is wider than the forward edge of the sleeve.

18. A greeting card comprising:
at least one leaf;
at least one compartment within the leaf; and
at least one sleeve slidably protruding from the compartment through a slot in the leaf so as to have a maximum extent from the slot in which more of the sleeve is outside the compartment than within the compartment and a minimum extent from the slot in which more of the sleeve is within the compartment than outside the compartment, the sleeve having a forward edge outside the slot when the sleeve is at the minimum and maximum extents and a rearward edge within the compartment when the sleeve is at the minimum and maximum extents, the sleeve having a pair of lateral edges between the forward and rearward edges, at least one of the lateral edges being open for receiving a gift that when disposed in the sleeve is concealed within the compartment if the sleeve is at the minimum extent relative to the slot, the sleeve being transparent such that a gift disposed in the sleeve is visible if the sleeve is at the maximum extent relative to the slot.

19. The greeting card according to claim 18, wherein the at least one compartment and the at least one sleeve comprises a first compartment disposed at a first lateral edge of the leaf and having a first sleeve slidably disposed therein, and a second compartment disposed at an oppositely-disposed second lateral edge of the leaf and having a second sleeve slidably disposed therein.

20. The greeting card according to claim 19, wherein the first sleeve is sized and configured for containing a gift therein and the second sleeve is sized and configured for containing a note card therein.
